(19) United States
(12) Patent Application Publication
(10) Pub. No.: US 2015/0151613 A1
(43) Pub. Date: Jun. 4, 2015

(54) CONTROLLING SYSTEM FOR TRANSPARENCY OF VEHICLE WINDOW AND METHOD FOR ADJUSTING TRANSPARENCY OF VEHICLE WINDOW

(71) Applicant: HON HAI PRECISION INDUSTRY CO., LTD., New Taipei (TW)

(72) Inventor: CHIH-CHUNG WENG, New Taipei (TW)

(21) Appl. No.: 14/510,589

(22) Filed: Oct. 9, 2014

(30) Foreign Application Priority Data
Dec. 2, 2013 (TW) 102143975

(51) Int. Cl. B60J 3/04; G01J 1/42; G01J 1/44; G02F 1/01

(52) U.S. Cl. CPC B60J 3/04; G02F 1/0121; G01J 1/4204; G01J 1/44

(57) ABSTRACT

A controlling system for transparency of vehicle windows includes a glass module, a control module, and a detection module. The control module electrically connects to the glass module and the detection module. The detection module includes a light sensor module connecting to the control module and a distance sensor module connecting to the control module. The light sensor module senses and transmits the level of the intensity of external light to the control module. The distance sensor module senses and transmits the distance between the windows and an obstacle outside the vehicle to the control module. The control module controls the glass module to change the transparency according to the light intensity and the distance. The present disclosure further provides a method for controlling system for transparency of vehicle windows.

### FIELD

The subject matter herein generally relates to environmental control, and in particular to a controlling system for transparency of a car window.

### BACKGROUND

Most vehicle windows are transparent or translucent. When a vehicle is exposed to the sun in hot weather during a prolonged parking period, the temperature in the vehicle will rise. In addition, the interior of the vehicle is exposed to heating because of the transparent vehicle windows.

### BRIEF DESCRIPTION OF THE DRAWINGS

Implementations of the present technology will now be described, by way of example only, with reference to the attached figures.

FIG. 1 is a block diagram of an embodiment of a controlling system for transparency of vehicle windows.

FIG. 2 is a flow chart of a process for a method for adjusting transparency of vehicle windows.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “outside” refers to a region that is beyond the outermost confines of a physical object. The term “comprising” when utilized, means “including, but not necessarily limited to”; it specifically indicates open-ended inclusion or membership in the so-described combination, group, series, and the like.

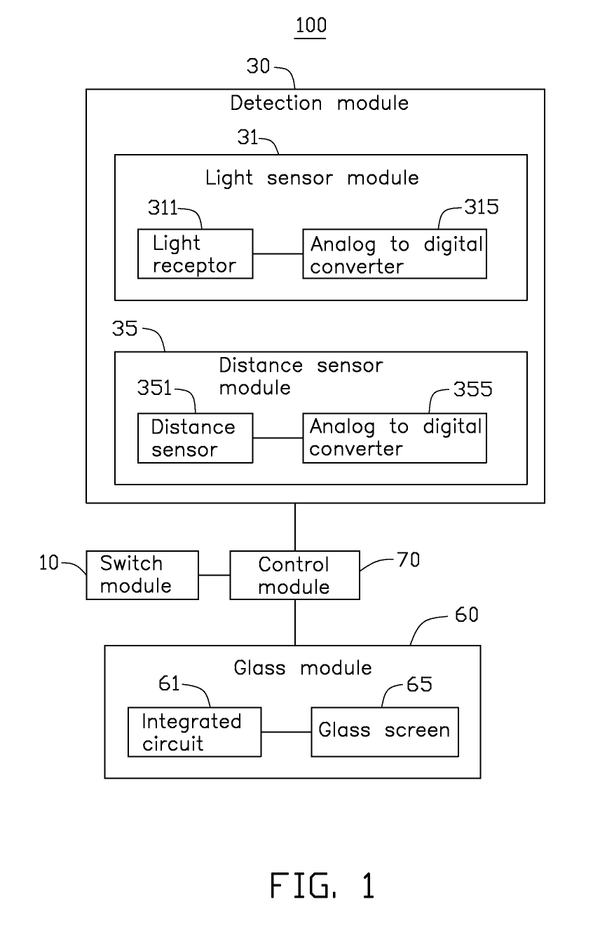

FIG. 1 illustrates an embodiment of a controlling system 100. The controlling system 100 can adjust transparency of a glass to insulate from heat and promote privacy for the occupants. The controlling system 100 can include a switch module 10, a detection module 30, a glass module 60, and a control module 70. The control module 70 can be electrically connected to the switch module 10, the detection module 30, and the glass module 60.

The switch module 10 can control a power supply to the control module 70 to control a power supply to the detection module 30 and to the glass module 60. The detection module 30 can measure the intensity of light and a distance between the window glass and an object (such as a person or a video camera). The control module 70 can adjust translucency of the glass module 60 according to information from the detection module 30. In at least one embodiment, the control module 70 can be an SCM (single chip microcomputer).

The detection module 30 can include a light sensor module 31 and a distance sensor module 35. The light sensor module 31 and the distance sensor module 35 can be electrically connected to the control module 70.

The light sensor module 31 can include a light receptor 311 and an analog to digital converter 315. The light receptor 311 can be electrically connected to the analog to digital converter 315. In at least one embodiment, the light receptor 311 can be a photodiode. The analog to digital converter 315 can be electrically connected to the control module 70. The light receptor 311 can sense the intensity of external light and convert the level of intensity to an electrical signal. The light receptor 311 can transmit the electrical signal to the analog to digital converter 315. The analog to digital converter 315 can convert the electrical signal to a digital signal, and transmit the digital signal to the control module 70.

The distance sensor module 35 can include a distance sensor 351 and an analog to digital converter 355. The distance sensor 351 can be electrically connected to the analog to digital converter 355, and the analog to digital converter 355 can be electrically connected to the control module 70. The distance sensor 351 can emit infrared light, and the infrared light can be reflected to the distance sensor 351 by an obstacle. The distance sensor 351 can measure a distance from an obstacle via an elapsed time of the reflected infrared, from being emitted. The distance sensor 351 can convert the distance to an electrical signal, and transmit the electrical signal to the analog to digital converter 355. The analog to digital converter 355 can convert the electrical signal to a digital signal, and transmit the digital signal to the control module 70.

The glass module 60 can include an integrated circuit 61 and a glass screen 65. The integrated circuit 61 can be electrically connected to the control module 70. The glass screen 65 can be electrically connected to the integrated circuit 61. The integrated circuit 61 can accept instructions from the control module 70, and control a translucency of the glass screen 65. Therefore, the transparency of the glass screen 65 can be changed.

The control module 70 can have presets of a first predetermined light intensity A and of a second predetermined light intensity B. The first predetermined light intensity A can be greater than the second predetermined light intensity B. In the illustrated embodiment, the first predetermined light intensity A can be 3000-lux, which can be equal to ambient light on a cloudy sky; the second predetermined light intensity B can be 300-lux, which can be equal to the intensity of ambient light during sunrise or sunset. The light intensity can be divided into three ranges via the first predetermined light intensity A and the second predetermined light intensity B. The control module 70 can have a preset of a predetermined privacy distance. If the obstacles are within the predetermined privacy distance, the control module 70 can adjust translucency of the glass module 60 to promote privacy for the occupants.

The control module 70 can accept a signal as to light intensity, and determine whether the light intensity falls within a range. If the light intensity is greater than or equal to the first predetermined light intensity A, the control module 70 can enter a daytime mode. The control module 70 can change the effective translucency of the glass screen 65 by changing it to give the appearance of a black color, to insulate against heating and protect privacy. In this situation, the transparency of the glass screen 65 can be a first transparency, and the amount of light which is able to pass through the glass screen 65 can be greater than or equal to 8% and less than or equal to 22% of the level of intensity of the light outside the vehicle. In the illustrated embodiment, a light intensity able to pass through the glass screen 65 can be 8%.

If the light intensity is less than the first predetermined light intensity A and greater than the second predetermined light intensity B, the control module 70 can enter the daytime mode. The control module 70 can change the translucency of the glass screen 65 by giving it the appearance of a gray color, which does not limit the clarity of an occupant's vision through the glass screen 65. In this situation, the transparency of the glass screen 65 can be a second transparency, and the amount of light which is able to pass through the glass screen 65 can be greater than or equal to 51% and less than or equal to 70% of the level of intensity of the light outside the vehicle. In the illustrated embodiment, the light intensity able to pass through the glass screen 65 can be 51%.

If the light intensity is less than or equal to the second predetermined light intensity B, the control module 70 can enter the night mode. When the distance between the vehicle and an obstacle outside the vehicle is greater than or equal to the predetermined privacy distance in the control module 70, the control module 70 can change the glass screen 65 into complete transparency to avoid limiting the clarity of vision of an occupant. In this situation, the transparency of the glass screen 65 can be a third transparency, and the amount of light which is able to pass through the glass screen 65 can be greater than or equal to 90% of the level of intensity of the light outside the vehicle. In the illustrated embodiment, the light intensity able to pass through the glass screen 65 can be 95%. When the distance between the vehicle and the obstacle outside the vehicle is less than the predetermined privacy distance in the control module 70, the control module 70 can change the glass screen 65 into black color to prevent privacy leaking In this situation, the transparency of the glass screen 65 can be the first transparency or the second transparency. In the illustrated embodiment, the light intensity able to pass through the glass screen 65 can be the first transparency and equal to 22%.

In at least one embodiment, the switch module 10 can be omitted to enable the controlling system 100 to run all the time. In at least one embodiment, the distance sensor module 35 can be omitted, thus where the light intensity is less than or equal to the second predetermined light intensity B, the control module 70 can render the glass screen 65 entirely transparent, and the light intensity of the third transparency can be greater than or equal to 90%.

In operation, the switch module 10 can be turned on, and the detection module 30, the glass module 60, and the control module 70 can be connected to a power source. The light receptor 311 can accept light, and the distance sensor 351 can emit and receive infrared light. The light sensor module 31 can transmit the signal generated by the light receptor 311 to the control module 70. The distance sensor module 35 can transmit the signal generated by the distance sensor 351 to the control module 70.

The control module 70 can measure the external light intensity and the distance between the vehicle and the obstacle outside the vehicle. If the light intensity is greater than 300-lux, the control module 70 can enter the daytime mode. If the light intensity is less than or equal to 300-lux, the control module 70 can enter the night mode. In the daytime mode, if the light intensity is greater than or equal to 3000-lux, the control module 70 can change the translucency of the glass screen 65 by giving it a black color, to insulate against heating and protect privacy; if the light intensity is less than 3000-lux and greater than 300-lux, the control module 70 can change the translucency of the glass screen 65 by giving it a gray color to insulate against heating and protect privacy, and the glass screen 65 can not limit the clarity of an occupant's vision through the window. In the night mode, the light intensity is less than 300-lux, if the distance between the vehicle and the obstacle outside the vehicle is greater than or equal to the predetermined privacy distance in the control module 70, the control module 70 can change the glass screen 65 to be transparent to avoid limiting the clarity of vision of an occupant in the vehicle; if the distance from the obstacle is less than the predetermined privacy distance, the control module 70 can make the glass screen 65 black to protect privacy.

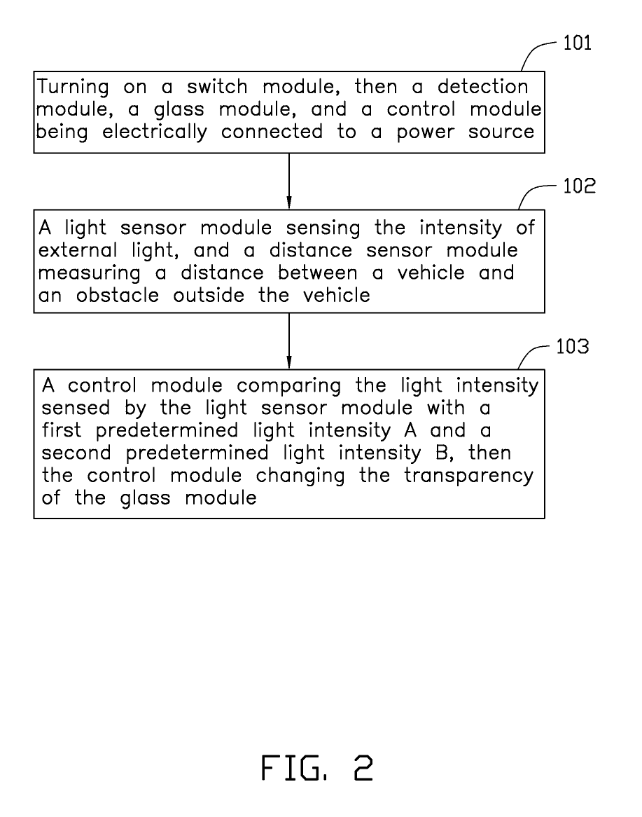

FIG. 2 illustrates a flowchart in accordance with an example embodiment. The example method is provided by way of example, as there are a variety of ways to carry out the method. The method described below can be carried out using the configurations illustrated in FIG. 1, for example, and various elements of the figure is referenced in explaining example method. Each block shown in FIG. 2 represents one or more processes, methods or subroutines, carried out in the example method. Additionally, the illustrated order of blocks is by example only and the order of the blocks can change according to the present disclosure. The example method can begin at block 101.

In block 101, a switch module 10 can be turned on, then a detection module 30, a glass module 60, and a control module 70 can be electrically connected to a power source.

In block 102, a light sensor module 31 can sense the intensity of external light, and a distance sensor module 35 can measure a distance between a vehicle and an obstacle outside the vehicle.

In block 103, a control module 70 can accept signals of the light intensity and the distance between the vehicle and the obstacle outside the vehicle. The control module 70 can have presets of a first predetermined light intensity A, of a second predetermined light intensity B and of a predetermined privacy distance. The control module 70 can change the translucency of a glass module 60 according to the signals. If the light intensity is greater than or equal to a first predetermined light intensity A, the control module 70 can change the effective translucency of a glass screen 65 by giving the appearance of a black color, and the amount of light which is able to pass through the windows of the vehicle can be greater than or equal to 8% and less than or equal to 22% of the level of intensity of the light outside the vehicle. If the light intensity is less than the first predetermined light intensity A and greater than a second predetermined light intensity B, the control module 70 can change the effective translucency of the glass screen 65 by giving the appearance of a gray color, and the amount of light which is able to pass through the windows of the vehicle can be greater than or equal to 51% and less than or equal to 70% of the level of intensity of the light outside the vehicle. If the light intensity is less than or equal to the second predetermined light intensity B and the distance between the vehicle and the obstacle outside the vehicle is greater than or equal to the predetermined privacy distance, the control module 70 can change the glass screen 65 into entirely transparent, and the amount of light which is able to pass through the windows of the vehicle can be greater than or equal to 90% of the level of intensity of the light outside the vehicle. If the light intensity is less than or equal to the second predetermined light intensity B and the distance between the vehicle and the obstacle outside the vehicle is less than the predetermined privacy distance, the control module 70 can change the translucency of the glass screen 65 by giving the appearance of a black color, and the amount of light which is able to pass through the windows of the vehicle can be greater than or equal to 8% and less than or equal to 22% of the level of intensity of the light outside the vehicle.

In at least one embodiment, the distance sensor module 35 can measure the distance from the obstacle after the control module 70 determines the light intensity is less than or equal to the second predetermined light intensity B.

The embodiments shown and described above are only examples. Many details are often found in the art such as the other features of a controlling system 100 for transparency of vehicle windows and a method for the controlling system 100 for transparency of vehicle windows. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A controlling system for transparency of vehicle windows configured to insulate against heating and protect privacy for occupants, the system comprising:
a glass module;
a control module electrically connected to the glass module, the control module presetting a first predetermined light intensity A, a second predetermined light intensity B, and a predetermined privacy distance; and
a detection module electrically connected to the control module, the detection module comprising a light sensor module, wherein the light sensor module senses an intensity of external light and transmit a level of the intensity to the control module;
wherein, if the light intensity is greater than or equal to the first predetermined light intensity A, the control module changes a transparency of the glass module into a first transparency;
if the light intensity is greater than the second predetermined light intensity B and less than the first predetermined light intensity A, the control module changes the transparency of the glass module into a second transparency, wherein the second transparency is greater than the first transparency;
if the light intensity is less than or equal to the second predetermined light intensity B, the control module changes the transparency of the glass module into a third transparency, wherein the third transparency is greater than the second transparency.

2. The controlling system for transparency of vehicle windows as claimed in claim 1, wherein:
the light sensor module comprises a light receptor and an analog to digital converter; and
the light receptor is electrically connected to the analog to digital converter, and the analog to digital converter is electrically connected to the control module.

3. The controlling system for transparency of vehicle windows as claimed in claim 2, wherein:
the light receptor converts the external light intensity to an electrical signal, and transmit the electrical signal to the analog to digital converter; and
the analog to digital converter converts the electrical signal to a digital signal, and transmit the digital signal to the control module.

4. The controlling system for transparency of vehicle windows as claimed in claim 1, wherein the detection module further comprises a distance sensor module, and the distance sensor module is electrically connected to the control module.

5. The controlling system for transparency of vehicle windows as claimed in claim 4, wherein:
the distance sensor module comprises a distance sensor and an analog to digital converter; and
the distance sensor is electrically connected to the analog to digital converter, and the analog to digital converter is electrically connected to the control module.

6. The controlling system for transparency of vehicle windows as claimed in claim 5, wherein:
the distance sensor converts the distance between the vehicle and an obstacle outside the vehicle to an electrical signal, and transmits the electrical signal to the analog to digital converter;
the analog to digital converter converts the electrical signal to a digital signal, and transmits the digital signal to the control module.

7. The controlling system for transparency of vehicle windows as claimed in claim 6, wherein:
the control module accepts the signals of the intensity of external light and the distance between the vehicle and the obstacle outside the vehicle;
if the light intensity is less than or equal to the second predetermined light intensity B and the distance between the vehicle and the obstacle outside the vehicle is greater than or equal to the predetermined privacy distance, the control module changes the glass module into the third transparency;
if the light intensity is less than or equal to the second predetermined light intensity B and the distance between the vehicle and the obstacle outside the vehicle is less than the predetermined privacy distance, the control module changes the glass module into the second transparency.

8. The controlling system for transparency of vehicle windows as claimed in claim 1, wherein:
the glass module comprises an integrated circuit and a glass screen; and
the integrated circuit is electrically connected to the control module, and the glass screen is electrically connected to the integrated circuit.

9. The controlling system for transparency of vehicle windows as claimed in claim 8, wherein the integrated circuit accepts an output instruction of the control module, and controls a translucency change of the glass screen.

10. The controlling system for transparency of vehicle windows as claimed in claim 1, wherein:
the light intensity of the first transparency is greater than or equal to 8% and less than or equal to 22% of the level of intensity of the light outside the vehicle;
the light intensity of the second transparency is greater than or equal to 51% and less than or equal to 70% of the level of intensity of the light outside the vehicle; and
the light intensity of the third transparency is greater than or equal to 90% of the level of intensity of the light outside the vehicle.

11. The controlling system for transparency of vehicle windows as claimed in claim 1, wherein the controlling system further comprises a switch module, and the switch module controls a power supply to the control module, the detection module and the glass module.

12. The controlling system for transparency of vehicle windows as claimed in claim 1, wherein:
the first predetermined light intensity A is equal to the ambient light on a cloudy sky, and the second predetermined light intensity B is equal to the intensity of ambient light during sunrise or sunset.

13. The controlling system for transparency of vehicle windows as claimed in claim 12, wherein the first predetermined light intensity A is 3000-lux, and the second predetermined light intensity B is 300-lux.

14. A method for adjusting transparency of vehicle windows, the method comprising:
a light sensor module sensing the intensity of external light;
a control module comparing the light intensity sensed by the light sensor module with a first predetermined light intensity A and a second predetermined light intensity B;
if the light intensity is greater than or equal to a first predetermined light intensity A, the control module changes a glass module into the first transparency;
if the light intensity is greater than the second predetermined light intensity B and less than the first predetermined light intensity A, the control module changes the transparency of the glass module into a second transparency, and the second transparency is greater than the first transparency;
if the light intensity is less than or equal to the second predetermined light intensity B, the control module changes the transparency of the glass module into a third transparency, and the third transparency is greater than the second transparency.
